(19) United States
(12) Patent Application Publication
(10) Pub. No.: US 2002/0168611 A1
(43) Pub. Date: Nov. 14, 2002

(54) Ultrasonic surgical dental tool having a chisel tip

(76) Inventor: Syngcuk Kim, City of Broomall, PA (US)

Correspondence Address: POLSTER, LIEDER, WOODRUFF & LUCCHESI, 763 SOUTH NEW BALLAS ROAD, ST. LOUIS, MO, 63141-8750, US

(21) Appl. No.: 09/851,852

(22) Filed: May 9, 2001

(51) Int. Cl. A61C 3/03; A61C 1/07

(52) U.S. Cl. 433/119; 433/165

(57) ABSTRACT

A dental tool for use with an ultrasonic transducer, includes a substantially elongate shaft having a proximal end with a coupling attachment at the proximal end for attachment to an ultrasonic handpiece or transducer, and a distal end having a tip configured as a cutting blade having an elongated substantially straight cutting edge, where, upon energization of the transducer, the cutting blade vibrates in a direction substantially coplanar to its cutting edge.

### REFERENCE TO RELATED APPLICATIONS

### STATEMENT REGARDING FEDERALLY SPONSORED RESEARCH OR DEVELOPMENT

Not Applicable.

### FIELD OF THE INVENTION

This invention relates generally to ultrasonic dental tools and pertains more particularly to special micro endodontic dental tools.

### BACKGROUND OF THE INVENTION

In the past decade, ultrasonic dental tools have come into greater use and have begun to replace many power and hand dental tools for drilling, cutting, shaping, cleaning and polishing teeth. Most of the prior art devices which have been powered have been powered by electric or air rotating motors. The tools useable with these power units were limited to rotating drills, cutters and grinders. The ultrasonic powered dental tools of recent years have several advantages over the prior art devices for most applications. Among the advantages are that they are smaller and lighter in weight and can be easily manipulated in and around dental structures in the oral cavity.

The ultrasonic power units have an entirely different type of motion than the rotary motion of air and electric motor powered units of the past. The motion imparted to the tool by an ultrasonic power unit is usually a small amplitude very high frequency or velocity oscillation or reciprocation. This motion is imparted to the working tip of the tool. The use of ultrasonic powered tools has resulted in the need for the development of entirely different types and sizes of tools. While many tools have been developed and are available for use with ultrasonic power units, there is a need for additional tools designed and configured to perform new and different procedures.

Recent years have seen greater use of ultrasonically powered instruments for the performance of many dental procedures including surgical procedures. Examples of ultrasonically powered instruments of this type for the preparation of root canals are disclosed in U.S. Pat. No. 4,019,254, issued Apr. 26, 1977 to Malmin, U.S. Pat. No. 5,094,617 issued Mar. 10, 1992 to Carr and PCT Publication WO 86/05967. With the exception of the first mentioned patent, all tools are formed with a shaft tapered to a point. More recent examples of improved tools are disclosed in U.S. Pat. No. 5,836,765, issued Nov. 17, 1998, and U.S. Pat. No. 5,868,570 issued Nov. 12, 1998.

In recent years ultrasonic tools have been used for many operations on teeth, bones, and soft tissue including dislodging and removal of dental material. These ultrasonic tools have been found to be particularly useful for micro dentistry and particularly for use in root canals. Tools for this purpose must be small, hard, durable and heat resistant in order to satisfactorily perform their function.

As an example, in the preparation of root canals, it has been found that the tool must be very small in order to work in the small canal areas. Such small tools must also be very strong and tough and able to withstand and/or easily dissipate and/or resist heat. In addition, when the dentist is preparing the root canals, they frequently form troughs between exposed ends of root canals. This formation of the trough is carried out with the same tool or tip used for cleaning out the canal. The resulting trough is often not uniform in cross section and is usually not straight. Accordingly there is a need for a special ultrasonic dental tool for forming uniform straight troughs.

Therefore, there is a need for improved ultrasonic dental tools formed of a suitable strong, flexible and durable heat resistant material with suitable configurations for new and different procedures to be performed. There is also a need for improved ultrasonic dental tools having configurations than enable forming uniform straight troughs.

### BRIEF SUMMARY OF THE INVENTION

A primary objective of this invention is to provide an improved ultrasonic dental tool having a tip that is formed of durable high strength heat resistant material having a configuration for performing new and different procedures, and particularly forming uniform straight troughs.

In accordance with a primary aspect of the present invention a dental tool for use with an ultrasonic transducer comprises an elongated unitary shaft member having a proximal end and a distal end, attachment means at said proximal end to enable detachable attachment to an ultrasonic transducer, and a cutting blade having an elongated substantially straight cutting edge at said distal end.

### BRIEF DESCRIPTION OF THE SEVERAL VIEWS OF THE DRAWINGS

The objects, advantages and features of this invention will be more readily appreciated from the following detailed description, when read in conjunction with the accompanying drawing, in which:

FIG. 1 is a side elevation view of an ultrasonic hand piece equipped with a dental tool constructed in accordance with a preferred embodiment of the invention;

FIG. 2 is an enlarged side elevation view of the dental tool of FIG. 1;

FIG. 3 is a side elevation view of an alternate embodiment of an ultrasonic dental tool of the present invention;

FIG. 4 is a side elevation view illustrating an early step in the machining process of making tools in accordance with the invention;

FIG. 5 is a side elevation view of another embodiment of an ultrasonic dental tool;

FIG. 6 is a side elevation view of a further embodiment of an ultrasonic dental tool;

FIG. 7 is a top plan view of a tooth with the crown removed showing root canals and a trench such as formed with tools in accordance with the; and

FIG. 8 is a diagrammatic cross sectional view of a typical ultrasonic handpiece having a tool of the present invention mounted thereon.

Corresponding reference characters represent corresponding parts throughout the several views of the drawings.

### DETAILED DESCRIPTION OF PREFERRED EMBODIMENTS

The present invention is described with reference to preferred embodiments of the invention as illustrated in the drawings. While this invention is described in terms of the best mode for achieving this invention's objectives, it will be appreciated by those skilled in the art that variations may be made in view of these teachings without deviating from the spirit or scope of the invention.

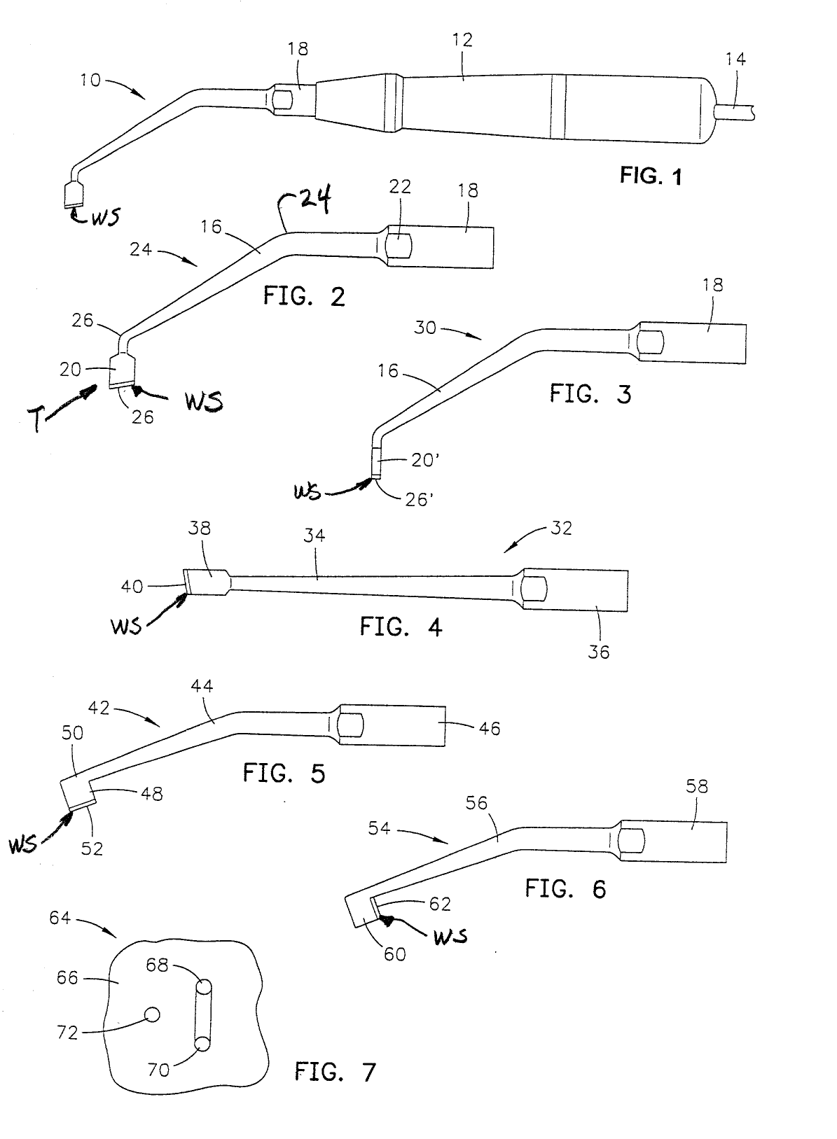

Referring to FIGS. 1 and 2 of the drawings there is illustrated an exemplary embodiment of a tool for dental surgical operations, in accordance with the present invention, designated generally by the numeral 10. The tool 10 is shown mounted in an end of an ultrasonic hand piece 12. An ultrasonic transducer or motor is mounted in the hand piece and is connected by a conductor within a line 14 to a converter box or power supply (not shown). The line 14 may also contain a water line or tube for conveying water or other fluids to the working tip. The tool 10 may also preferably be formed with means to get water or fluid to the working edge of the surgical tip of the tool. The ultrasonic transducer (not shown) within the hand piece is connected to a shaft (not shown) that extends from the front of the hand piece to which the tool is attached by a suitable detachable connection. Such power supplies and handpieces are well know and are commercially available. One such ultrasonic power supply and handpiece is available from Spartan Marketing Group, 1663 Fenton Business Park Court, Fenton, Mo. 63026.

The tool, as illustrated, comprises an elongated shank 16 having a connection, as indicated at 18, at its first or proximal end and a chisel like cutting blade 20 at a second or distal end. The connection is preferably in the form of a threaded socket (not shown) on the proximal end having internal threads for threadably receiving male threads on the end of the handpiece 12. The proximal end of the tool has a flat 22 on each side for engagement by a wrench or the like for rotating the tool and tightening and loosening the tool. Other well known connection systems may be used in place of the above described threads. For example, a bayonet lock or a tool chuck may be used in place of such threads.

The tool is formed with an elongated tapered shank or shaft 16 which has a bend 24 between the proximal end and the distal end so that the distal end portion is curved away from the primary axis of the shank to form what is commonly called a tip T. The tip as used herein means that portion of the tool at the outer or distal end configured to have a working surface or cutting edge WS.

The bend 24 in the shank of the tool is shown to be approximately ⅓ of the length along the tapered shank from the connecting member to the tip. It may be anywhere between about ⅓ and ⅔ along the length of the shank from the connecting member to the tip. It may be anywhere between ⅓ and ⅔ along the length of the shank and is devised to position the working tip at a convenient position and angle for ease of holding and use by the user. This positions the working tip at a convenient angle in the oral cavity with respect to the hand piece being held and manipulated by the user.

The shank 16 of tool 10 may have a uniform taper along its length or it may have a compound taper such that it tapers a slight degree or taper along a first ⅓ to ½ portion and tapers at a slightly higher angle or taper along the remainder of the shank. The overall tool is constructed and configured to be tuned to and be matched to the impedance (i.e., frequency and amplitude) of the ultrasonic transducer (generator) and the power supply.

The working tip of the tool as shown is in the form a blade 20 which in the FIG. 1 embodiment is at the very outer tip of the shank which tapers down to a second bend 26 which is closely adjacent outer end of the shank and the blade 20. This bend positions and orients the blade relative to the shank and the hand piece for the tool. The blade 20 is formed or configured by machining as a flat almost rectangular blade with parallel or slightly angled opposed faces and side edges terminating in a cutting edge 28 that extends substantially straight at a slight angle to the blade member. The cutting edge is angled to extend at a desirable angle relative to the hand piece such that the overall cutting surface or edge is at a comfortable working angle to the hand piece for the user. The cutting edge 26 of the blade is formed by a sharp V-shaped edge formed with surfaces that intersect at the edge at appropriate angles that may be up to 45 degrees, but smaller angles may be preferred.

Referring now to FIG. 3, an alternate embodiment of the cutting tool of the present invention is illustrated and designated generally by the numeral 30. In this embodiment, identical elements will be identified by the same numeral and comparable elements will be identified by the numeral primed. In this embodiment the shaft or shank 16 and connecting means 18 are identical to the previous embodiment with a working tip 10 formed or configured to have a surface area and length that is about equal to the diameter of the shank at the tip. In this instance likewise the cutting edge 26 has a length that is substantially equal to the diameter of the shank at its uttermost tip.

It is contemplated that a set of the tools will be provided having lengths, widths and angles that may vary with the lengths of the cutting edge. The cutting edge will have a length varying between the length of the edge shown in FIG. 3 up to a length such as shown for example in FIGS. 1 and 2. Exemplary dimensions of a typical exemplary embodiment are with a total length of the tool of about 1.5 inches with the shank and tip having a length of approximately 1.2 inches. In one embodiment, the shank has a taper from approximately 0.085 inches at the connecting member down to 0.60 proximate the center thereof and further tapering from that point to approximately 0.025 at the juncture of the working tip. An exemplary working tip of the FIGS. 1 and 2 embodiment may have a blade length along its axis of about 0.10 with a width of about 0.080 and a thickness of about 0.025. It will be appreciated that these may vary to meet the particular needs of the particular application. It will also be appreciated that the tool will need to be tuned so as to resonate with the particular ultrasonic handpiece and power supply with which it is to be used so that it will operate when the handpiece is energized.

Referring to FIG. 4, another embodiment of the tool is illustrated designated generally by the numeral 32 and having a connector 34 and a blade tip 36. In this embodiment the shank is substantially the same in basic construction as in the previous embodiment but is configured to remain straight. A tool of this configuration may have different applications to that of the previous embodiment in that the blade is presented to extend transverse to the axis of the straight shank. This tool may be used in applications such as wherein the blade may be used for planing of a tooth surface or bone surface. It will also be appreciated that this embodiment also illustrates an intermediate step in the formation of the tools of FIGS. 1-3 prior to introducing a bend into the shank.

Referring to FIG. 5, a further embodiment is illustrated wherein a tool designated generally at 42 has a shank as in prior embodiments configured substantially as in prior embodiments with a connector member 46 and a blade 48 at the outer or distal end. The blade in this instance is disposed entirely along and to one side of the outer or distal end 50 of the shank 44. The blade 48 has an edge 52 as in previous embodiments which extends at an angle which in the illustrated embodiment is at an angle to the primary axis of the shank and the hand piece. This configuration may have certain advantages in certain situations such as when used in planing as opposed to forming troughs between canals. The configuration may in some instances be a little more difficult to tune to the ultrasonic transducer. Preferably, the blade is formed as an integral part of the shank as opposed to being attached thereto such as by welding.

Referring to FIG. 6, still another embodiment of the invention is illustrated and designated generally by the numeral 54. This embodiment as in previous embodiment has a tapered shank 56 configured as in the previous embodiment with a connector 58 and a blade 60 at the outer or distal end. In this embodiment the blade is as in the previous embodiment in the form of a generally flat rectangular blade having a cutting edge 62 which in this embodiment extends substantially at right angles to the axis of the outer portion of the shank 56. This as in the immediately previous embodiment is configured to be useful in planing and the like. The cutting edge 62 may extend at various angles to the outer end of the shank but in general extends at an angle outward from the axis of the outer portion of the shank.

In operation, the tools described herein were developed predominately for the formation of troughs or trenches between root canals of a tooth. Referring to FIG. 7, a top plan view of a tooth designated generally by the numeral 64 having the crown removed to reveal an underlying surface 66 of the body having a plurality of root canals 68, 70 and 72 is illustrated. In microdentistry, a number of operations are performed under microscope including the treatment of root canals. In the past, this has been carried out with tools as disclosed and covered for example in U.S. Pat. No. 5,868,570 entitled Ultrasonic Dental tool issued Feb. 9, 1999, incorporated herein by reference. In the prior art as the root canals were being cleaned with an ultrasonic instrument the operator traditionally formed troughs between adjacent canals. With the prior tools it was difficult to maintain a straight end uniform trough between the canals. The tools with blades in these embodiments enable easier and more uniform formation of troughs between root canals.

The present tools were devised and configured to enable the use of an ultrasonic transducer in the creation of uniform and straight canals or troughs between root canals of a tooth. The tool is preferably constructed of a good medical grade of stainless steel, but may be constructed of a titanium alloy of a medical grade. Medical grade alloy means a material that may be used in contact with food and with a patients body without undergoing a chemical reaction. A titanium alloy that has been found to be satisfactory and which is preferred is identified as 6AL/4V ELI & CP Grade 4 and is available from President Titanium of Hanson, Mass. This material to be sufficiently hard, durable and flexible to resist breakage under use. Likewise, various coatings may be applied to the tip to achieve its purpose. Suitable stainless steels include 13-8Mo and 17-4PH.

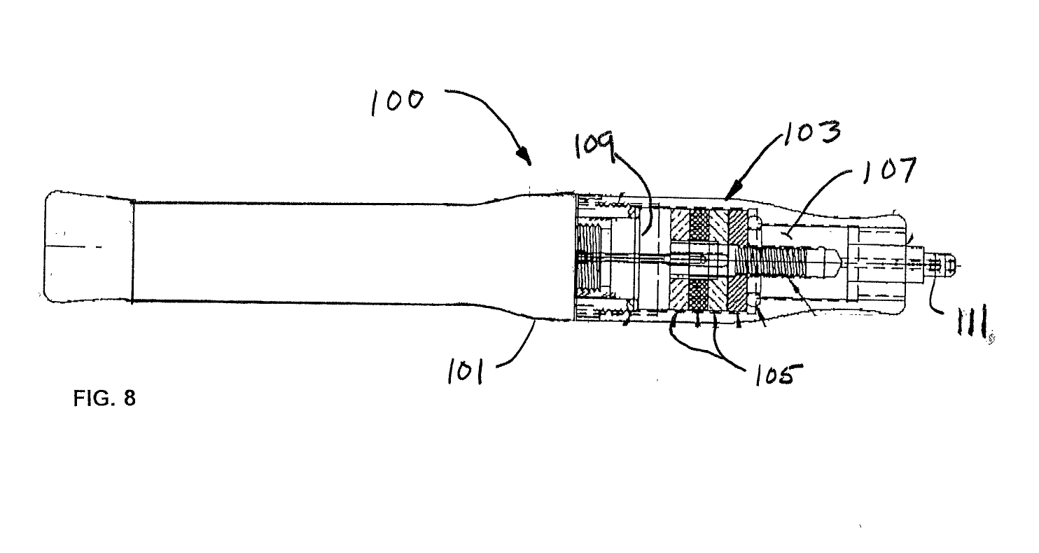

Referring to FIG. 8, a typical ultrasonic handpiece is indicated at 100. The handpiece has a body 101 which is configured so as to conveniently held by a clinician using the handpiece. Within the handpiece, an ultrasonic transducer 103 is provided. Typically, such a transducer comprises a stack of piezoelectric wafers 105 which vibrate upon being energized by oscillating electrical power supplied by a power supply (not shown) in the well known manner. The piezoelectric wafers 105 are firmly clamped between a front mass 107 and a back mass 109. The front mass 107 has a threaded stud 111 extending longitudinally from the handpiece. As described above, the tool 10 of the present invention is provided with a threaded recess at its proximal end having internal thread which threadably receives the external threads on stud 111 so as to permit a tool 10 of the present invention to be secured to the handpiece and to be removed therefrom. Such a threaded connection between the transducer and the tool effectively transmits vibrations from the transducer to the tool. Upon energization of the transducer by the power supply at its predetermined frequency (e.g., 40,000 Hz.), the transducer with cause the treaded stud 111 to vibrate in longitudinal direction at the frequency of the transducer (e.g., 40,000 Hz.). The amplitude of these vibrations will vary in proportion to the power supplied to the transducer, but, in general, the amplitude of these vibrations is quite small, for example, on the order of about 0.001 inches. With the tool 10 of the present invention, as shown in FIGS. 1, 2, and 5, installed on the handpiece 100, these vibrations will cause the cutting or working surface WS of the blade to reciprocate or move in a plane generally parallel to the plane of the blade such that the cutting surface of the blade will vibrate (or reciprocate) back and forth along the cutting surface to thus cut tissue or tooth material in a highly controllable manner.

While I have illustrated and described my invention by means of specific embodiments, it is to be understood that numerous changes and modifications may be made therein without departing from the spirit and the scope of he invention as defined in the appended claims.

1. A dental tool for use with an ultrasonic transducer, the tool comprising:
an elongated unitary shaft member having a proximal end and a distal end;
attachment means at said proximal end to enable detachable attachment to an ultrasonic transducer; and
a cutting blade having an elongated substantially straight cutting edge at said distal end.

2. The tool of claim 1, wherein said shaft has a bend intermediate said proximal end and said distal end forming said cutting edge extending at an angle to said shaft.

3. The tool of claim 2, wherein said cutting edge extends at an angle of between about 80 and 90 degrees to the shaft at said distal end.

4. The tool of claim 3, wherein said cutting edge has a length at least equal to the diameter of said shaft at said distal end.

5. The tool of claim 4, wherein said cutting edge is formed along an edge of a flat portion of said shaft at said distal end.

6. The tool of claim 1, wherein said cutting edge extends along a side of said shaft.

7. The tool of claim 6, wherein said cutting edge is formed along an edge of a flat portion of said shaft at said distal end.

8. The tool of claim 7, wherein said shaft has a bend intermediate said proximal end and said distal end forming said tip extending at an angle to said shaft.

9. The tool of claim 9 wherein said tip has a continuous taper from said attachment means to said distal end.

10. The tool of claim 1, wherein said shaft has a bend intermediate said proximal end and said distal end forming said tip extending at an angle ranging between about 15 degrees to about 45 degrees.

11. The tool of claim 10, wherein said tip extends at an angle of between 75 and 90 degrees to said shaft.

12. The tool of claim 9, wherein said shaft has at least one bend between said attachment means and said bend forming said tip.

13. The tool of claim 12, wherein said shaft has multiple bends between said attachment means and said bend forming said tip.

14. A dental tool for use with an ultrasonic transducer, the tool comprising:
an elongated unitary shaft member having a primary longitudinal axis, a proximal end and a distal end;
attachment means at said proximal end for enabling detachable attachment to an ultrasonic transducer; and
a flat area at said distal end defining a cutting blade having an elongated substantially straight cutting edge extending at an angle to said primary axis.

15. The tool of claim 14, wherein said cutting edge has a length of at least equal to the diameter of said shaft at said distal end.

16. The tool of claim 14, wherein said cutting blade is displaced to one side of said primary axis.

17. The tool of claim 14, wherein said shaft tapers down from said proximal end to said distal end and has a bend in within about a center one third of said shaft whereby said distal end is offset from said primary axis.

18. The tool of claim 17, wherein at least one third of said shaft at said distal end at an angle of between fifteen and forty-five degrees, and said cutting blade is displaced to one side of said at least one third of said shaft.

19. The tool of claim 18, wherein said cutting edge extends at an angle of between about five and twenty degrees to said at least one third of said shaft.

20. The tool of claim 18, wherein said cutting edge extends at an angle of between about five and fifteen degrees to said at least one third of said shaft.

21. A dental tool for use with an ultrasonic dental handpiece, said handpiece having a threaded stud coupled to an ultrasonic transducer within said handpiece, said transducer vibrating at a predetermined frequency upon energization of said transducer by oscillating electrical power, said tool having a proximal end threadably attached to said threaded stud and a distal end with a shank extending between said proximal and distal ends, said tool having a blade cutting surface at said distal end, said tool being rendered resonant upon energization of said transducer such that said blade cutting surface vibrates at substantially the resonant frequency of said tool in the plane of said blade cutting surface.
